(19) United States
(12) Patent Application Publication
(10) Pub. No.: US 2026/0110323 A1
(43) Pub. Date: Apr. 23, 2026

(54) Lock Bolt with Anti-excessive Screwing Function

(71) Applicant: Yibo JIANG, Beijing (CN)

(72) Inventor: Yibo JIANG, Beijing (CN)

(21) Appl. No.: 18/919,488

(22) Filed: Oct. 18, 2024

(51) Int. Cl. F16B 31/02; F16B 39/28

(52) U.S. Cl. CPC F16B 31/021; F16B 39/28

(57) ABSTRACT

A lock bolt with an anti-excessive screwing function comprises a screw, one end of which is threaded with a nut, wherein the screw is provided with a filler which can fill the gap between screw holes; wherein, the nut comprises a sleeve body, with one end of the sleeve body connected; the connecting sleeve is provided with a connecting rib attached to the sleeve body, which will break when subjected to excessive torsion.

### TECHNICAL FIELD

The present disclosure relates to a bolt connection structure, in particular to a bolt connection structure for avoiding excessive screwing.

### BACKGROUND

Bolt connection is a very common connection method in both production and life. Generally, the nut of bolt connection cannot limit the applied torque during tightening, and the tightness of nut screwing is mostly judged by workers' experience. Accordingly, when the nut is screwed too tightly, it will lead to the damage of thread pair, thus shortening the life of fastener; while when the nut is too loose, it will lead to the problem of unstable fixation; in addition, when the screw is connected through a bolt hole with a larger diameter, it is difficult to be coaxial with the hole, and it is impossible to achieve a better fit. At the same time, after the head part of the screw contacts the connecting surface, slippage between the two parts is likely to occur.

For example, the US patent No. 20210003163 discloses a “BOLT AND FASTENING STRUCTURE”. The patent does not have the function of preventing bolt damage caused by excessive torque or the function of improving the coaxiality of bolt and nut.

Therefore, there is a need to put forward a new type of bolt, which can protect the thread when the torque is too large, and at the same time improve the coaxiality of the bolt and nut.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides a lock bolt with an anti-excessive screwing function, so as to solve the problems that it is difficult to disassemble the bolt after fastening, and it is difficult to be coaxial with a connecting hole with a larger diameter when the screw is connected through the bolt connecting hole, so that a better fit cannot be achieved, and at the same time, after the head part of the screw contacts the connecting surface, the two are likely to slide.

In order to solve the above problems, the present disclosure adopts the following technical solutions.

The present disclosure provides a lock bolt with an anti-excessive screwing function, which includes a screw, one end of which is threaded with a nut; the screw is provided with a filler which is capable of filling a gap between screw holes; the nut includes a sleeve body, and one end of the sleeve body sleeved with a connecting sleeve; the connecting sleeve is provided with a connecting rib attached to the sleeve body, and the connecting rib can be broken after being subjected to torsion overload.

The present disclosure further provides a lock bolt with an anti-excessive screwing function, which includes a screw, one end of which is threaded with a nut; an overload protection component is provided on the nut, and the overload protection component protects the nut and the screw after torsion overload; lugs which can fill gaps between screw holes are evenly provided on the screw in a circumferential direction.

The present disclosure further provides a lock bolt with an anti-excessive screwing function, which includes a screw, one end of which is threaded with a nut; the nut includes a sleeve body; two ends outside the sleeve body are respectively sleeved with a gasket and a connecting sleeve, the connecting sleeve is provided with a connecting rib attached to the sleeve body, and the connecting rib can be broken after being subjected to torsion overload; a limit structure for limiting the movement of the gasket is provided between the gasket and the sleeve body.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic diagram of the three-dimensional structure of the present disclosure.

FIG. 2 is a schematic diagram of the three-dimensional structure of the screw in the present disclosure.

FIG. 3 is a schematic diagram of the three-dimensional structure of the screw in the present disclosure from another perspective.

FIG. 4 shows the three-dimensional structure of the nut in the present disclosure.

FIG. 5 is a perspective view of the nut in the present disclosure.

FIG. 6 is a schematic diagram of the three-dimensional structure of the gasket in the present disclosure.

FIG. 7 is a perspective view of the nut in the present disclosure.

FIG. 8 is a state diagram after the connecting sleeve of the present disclosure falls off.

FIG. 9 is a structural diagram of another embodiment of FIG. 4.

Reference signs: Screw (100); Head part (101); Rod part (102); Glossy surface (112); Threaded surface (122); Filler (162); Lug (132); Inclined surface (142); Arc surface (152); Anti-slip ripple (121); Cross notch (111); Gasket (200); Clamping ring (201); Nut (300); Sleeve body (301); Connecting sleeve (302); Limit ring (303); Cylinder (304); Chamfer (305); Limit protrusion (306); Internal thread (307); Hexagonal prism (308); Connecting rib (312).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

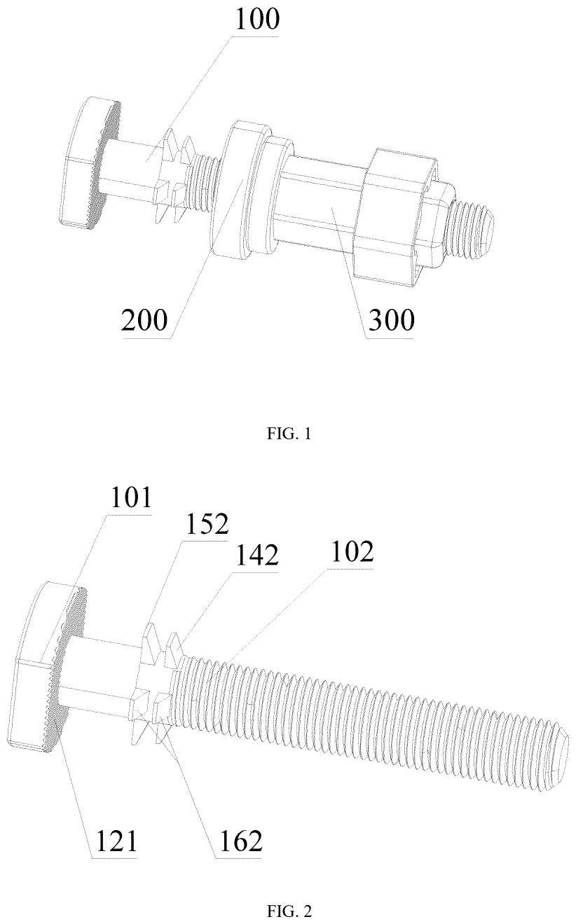

As shown in FIG. 1 to FIG. 8, the present disclosure provides a lock bolt with an anti-excessive screwing function, which includes a screw 100, one end of which is threadedly connected with a nut 300, and the screw 100 is provided with a filler 162 which can fill the gap between screw holes. The nut 300 includes a sleeve body 301, the middle of which is provided with an internal thread 307. One end of the sleeve body 301 is sleeved with a connecting sleeve 302. The connecting sleeve 302 is provided with a connecting rib 312 attached to the sleeve body 301, and the connecting rib 312 can be plastically deformed and broken after being subjected to torsion overload.

The sleeve body 301 passes through the internal thread 307. When the screw 100 is twisted, the connecting sleeve 302 can be clamped with a wrench, and the connecting sleeve 302 is connected with the sleeve body 301 through the connecting rib 312. Therefore, by screwing the connecting sleeve 302 with a wrench to rotate, the sleeve body 301 can be driven to rotate synchronously, and then the sleeve body 301 and the screw 100 are screwed.

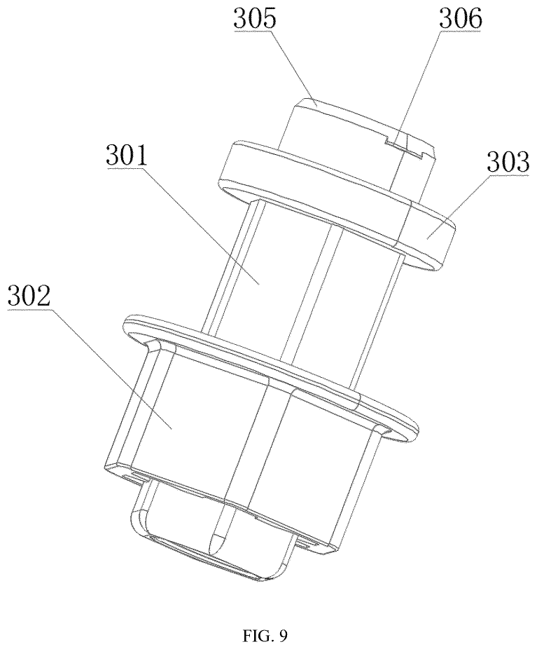

The connection strength between the connecting rib 312 and the connecting sleeve 302 is carefully designed. After the screw 100 is screwed with the internal thread 307 in the sleeve body 301, if the torque is continuously applied, the connecting rib 312 can be plastically deformed and broken after the torque overload, and can be disengaged from the sleeve body 301 and the connecting sleeve 302, as shown in FIG. 8. At this time, the torque can not continue to screw the screw 100 into the sleeve body 301, thus protecting the threads between the nut 300 and the screw 100 as well as the intermediate locking material.

In other embodiments (not shown), in addition to the connecting ribs 312, fracture pins, fusible alloys, preset crack structures and the like can be used. These structures can all break when they are overloaded by a predetermined torque, so as to prevent excessive tightening.

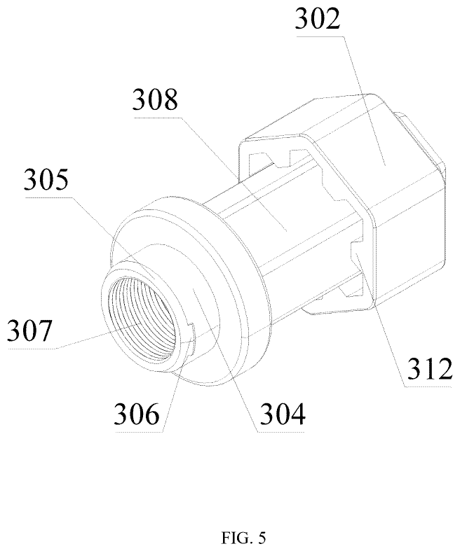

As shown in FIG. 4 and FIG. 5, the end of the sleeve body 301 far away from the connecting sleeve 302 is provided with a limit ring 303, which can prevent the gasket 200 from moving on the sleeve body 301 when the gasket 200 is attached to the limit ring 303. By providing the gasket 200, the contact area between the nut 300 and the object can be increased when the bolt is used, and the friction can be increased, so that the nut 300 is firmer after being locked.

The sleeve body 301 includes a hexagonal prism 308 located on the side of the limit ring 303 close to the connecting sleeve 302, and a cylinder 304 located on the side of the limit ring 303 far from the connecting sleeve 302. The cylinder 304 can be inserted and fitted with the gasket 200. The top of the cylinder 304 is provided with a chamfer 305, and the chamfer 305 is provided with a limit protrusion 306. The limit protrusion 306 provided on the chamfer 305 has an inclined angle and can abut against the clamping ring 201.

In this embodiment, the hexagonal prism 308 and the connecting sleeve 302 are both hexagonal structures, so that the hexagonal prism 308 can be fitted with the connecting sleeve 302, which facilitates the attachment of the connecting rib 312 to the sleeve body 301, thereby engaging and fixing the sleeve body 301 and the connecting sleeve 302. At the same time, after the connecting rib 312 falls off due to torsion overload, if the locked bolt connection structure is to be loosened, the hexagonal prism 308 can also fix the sleeve body 301 with the aid of a hexagonal wrench, so that the screw 100 is twisted to unscrew it from the sleeve body 301.

In other embodiments (not shown), the connecting sleeve 302 and the sleeve body 301 may be separately arranged. That is, the connecting rib 312 and the hexagonal prism 308 are connected by movable contact. Therefore, when the connecting sleeve 302 is not used, it can be removed from the sleeve body 301 and used when necessary. In this way, the applicability of the present disclosure can be improved and the requirements of different application scenarios can be met.

In other embodiments (not shown), the limit ring 303 can be replaced with any shape with similar effect of increasing the contact area, such as a flange with an increased diameter, a disk surface with a concave-convex texture, etc., as long as these alternative structures can provide enough contact area and enhance the locking effect; The connecting sleeve 302 and the hexagonal prism 308 can also be replaced with any shapes that can be conveniently rotated by tools such as wrenches and screwdrivers, for example square columns, dodecagonal columns or designs with special grooves, as long as these shapes are compatible with the corresponding tools.

In another embodiment of the connecting sleeve 302, as shown in FIG. 9, one end edge of the connecting sleeve 302 can also be provided with an annular protrusion, which can play a role in positioning and limiting when the external hexagon wrench is sleeved outside the connecting sleeve 302, so as to prevent the entire connecting sleeve 302 from entering the interior of the external hexagon wrench.

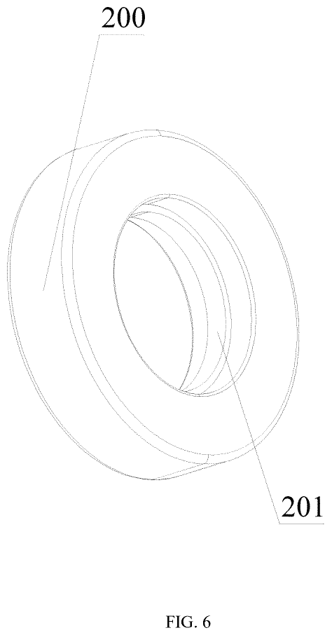

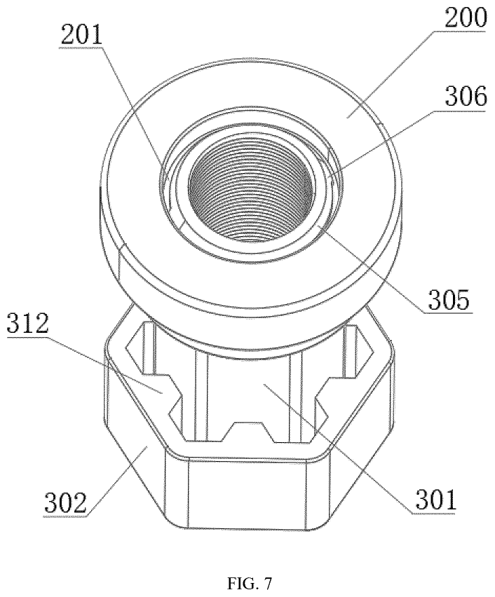

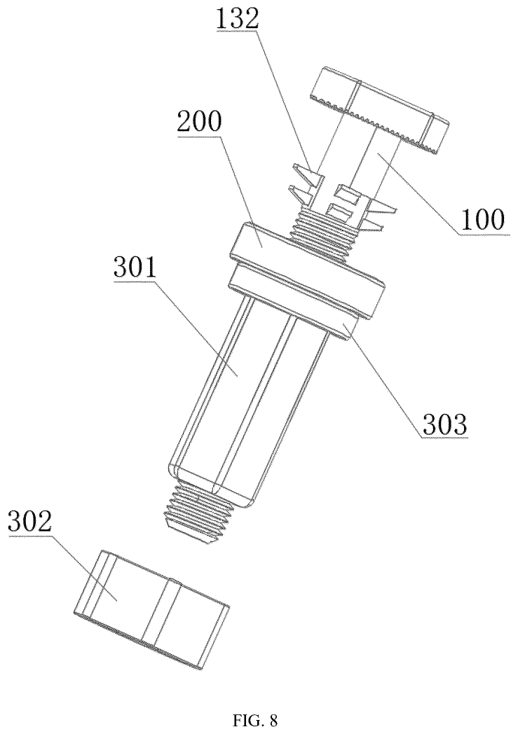

As shown in FIG. 6 and FIG. 7, the screw 100 is sleeved with a gasket 200, which is annular, and the inner wall of the gasket 200 is fixedly provided with a clamping ring 201. When the cylinder 304 is inserted into the gasket 200, the inclined limit protrusion 306 on the chamfer 305 will pass through the clamping ring 201 and be attached to the end face of the clamping ring 201 facing the head part 101, so that the limit protrusion 306 can be fitted with the limit ring 303. The gasket 200 can be limited to the sleeve body 301, so that the gasket 200 does not easily loosen on the sleeve body 301, so as to make the nut 300 and the screw 100 more secure after locking.

Moreover, in this embodiment, the limit protrusion 306 has certain elasticity, and the outer surface of the limit protrusion 306 is an arc surface. Therefore, by fitting the chamfer 305 with the arc surface of the limit protrusion 306, when the cylinder 304 is inserted into the gasket 200, the limit protrusion 306 can pass through the clamping ring 201 more smoothly and be attached to the end surface of the clamping ring 201 facing the head part 101.

Of course, the limit structure is not limited to the above-mentioned embodiments. In other embodiments of the limit structure (not shown), the cooperation between the limit protrusion 306 and the clamping ring 201 can be replaced by the form of clamping with grooves. Alternatively, it can be replaced by interference fit. Of course, any other mode that can easily limit the gasket 200 can also be adopted.

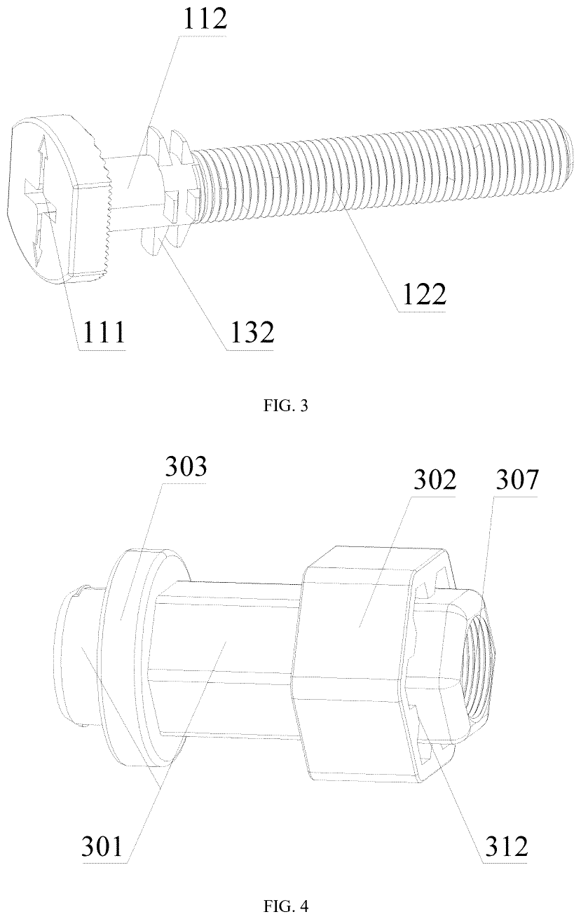

As shown in FIG. 2 and FIG. 3, the screw 100 includes a head part 101 and a rod part 102. One end of the rod part 102 close to the head part 101 is provided with a glossy surface 112, and the other end away from the head part 101 is provided with a threaded surface 122. The filler 162 includes lugs 132 evenly arranged in the circumferential direction on the glossy surface 112, and one end of the lug 132 close to the threaded surface 122 is an inclined surface 142. When the screw 100 passes through a screw hole of a screw connector, the inclined surface 142 can help the screw 100 to smoothly enter the screw hole. The end of the lug 132 far from the rod part 102 is an arc surface 152, which can be attached to the arc inner wall of the screw hole, so as to facilitate the filling of the gap with the screw hole, reduce the gap when the screw 100 passes through the hole and achieve a better fit. At the same time, the coaxiality between the screw 100, the screw hole and the nut 300 is improved, so as to avoid skew between the screw 100 and the nut 300 and prevent the screw thread from being damaged or stuck.

In other embodiments (not shown), the lug 132 can be replaced by structures with other shapes, such as spiral grooves, annular grooves or gaskets with elastic materials, which can further provide smooth entry and a tight fit. The spiral groove can guide the screw 100 into the screw hole through its gradually changing depth, while the annular groove or gasket can fill the gap and provide additional fixing effect.

In other embodiments (not shown), the filler 162 can be replaced by other types of filler elements, such as O-rings, elastic gaskets or metal gaskets with special shapes. These components can be customized according to the specific shape and size of the screw hole to provide smaller clearance.

As shown in FIG. 3, the head part 101 is provided with a cross notch 111 at the end far away from the rod part 102, which can be fitted with a screwdriver and other tools to turn the screw 100, and the end close to the rod part 102 is provided with a concave-convex anti-slip ripple 121, so that greater friction is generated between the screw 100 and the screw connector, and the locking of the screw 100 is firmer.

In other embodiments (not shown), the cross notch 111 can be replaced with other types of notch designs, such as a slotted head, a hexagonal slot (for a hexagonal wrench), a quincunx slot (for a quincunx wrench) or an inner hexagonal slot (for an Allen wrench). These notches can further provide fitting with corresponding tools to rotate the screw 100.

In other embodiments (not shown), the anti-slip ripples 121 can be replaced by other types of anti-slip structures, such as rough surfaces, bumps, grooves, threads or specially shaped textures. These structures can provide additional friction to ensure a firm connection between the screw 100 and the screw connector.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or understood from the context, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The terms “adapted to” or “configured to” are used here as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently from what is described. For example, elements may be added to, removed from, or rearranged compared to the disclosed examples.

What is claimed is:

1. A lock bolt with an anti-excessive screwing function, comprising a screw, one end of which is threaded with a nut, wherein
the screw is provided with a filler which is capable of filling a gap between screw holes; and
wherein the nut comprises a sleeve body, and one end of the sleeve body sleeved with a connecting sleeve; the connecting sleeve is provided with a connecting rib attached to the sleeve body, and the connecting rib can be broken after being subjected to torsion overload.

2. The lock bolt with an anti-excessive screwing function according to claim 1, wherein an end of the sleeve body far from the connecting sleeve is provided with a limit ring, and the middle of the sleeve body is provided with an internal thread.

3. The lock bolt with an anti-excessive screwing function according to claim 2, wherein a gasket is sleeved on the screw.

4. The lock bolt with an anti-excessive screwing function according to claim 1, wherein the screw comprises a head part and a rod part; one end of the rod part close to the head part is provided with a glossy surface, and the other end far from the head part is provided with a threaded surface.

5. The lock bolt with an anti-excessive screwing function according to claim 2, wherein the filler comprises lugs evenly provided on the glossy surface in a circumferential direction.

6. The lock bolt with an anti-excessive screwing function according to claim 5, wherein one end of each lug facing the threaded surface is an inclined surface, and the other end of the lug far from the rod part is an arc surface.

7. The lock bolt with an anti-excessive screwing function according to claim 4, wherein an end face of the head part facing away from the rod part is provided with a cross notch, and an end face facing the rod part is provided with concave-convex anti-slip ripples.

8. The lock bolt with an anti-excessive screwing function according to claim 3, wherein the gasket is annular, and an inner wall of the gasket is fixedly provided with a clamping ring.

9. The lock bolt with an anti-excessive screwing function according to claim 8, wherein the sleeve body comprises a hexagonal prism and a cylinder respectively located at the two sides of the limit ring; and
wherein, the hexagonal prism is attached to the connecting rib, and the cylinder is inserted and fitted with the gasket.

10. The lock bolt with an anti-excessive screwing function according to claim 9, wherein a top of the cylinder is provided with a chamfer, and the chamfer is provided with a limit protrusion with the clamping ring; and
when the cylinder is inserted into the gasket, the limit protrusion passes through the clamping ring and abuts against the end face of the clamping ring.

11. A lock bolt with an anti-excessive screwing function, comprising a screw, one end of which is threaded with a nut, wherein
an overload protection component is provided on the nut, and the overload protection component protects the nut and the screw after torsion overload; and
wherein, lugs which can fill gaps between screw holes are evenly provided on the screw in a circumferential direction.

12. The lock bolt with an anti-excessive screwing function according to claim 11, wherein the overload protection component comprises a sleeve body; one end of the sleeve body is sleeved and connected with a connecting sleeve, one end of the sleeve body far from the connecting sleeve is provided with a limit ring, and the connecting sleeve is provided with a connecting rib attached to the sleeve body; and the connecting rib can be broken after being subjected to torsion overload.

13. The lock bolt with an anti-excessive screwing function according to claim 11, wherein the screw comprises a head part and a rod part; one end of the rod part close to the head part is provided with a glossy surface, and the other end far from the head part is provided with a threaded surface.

14. The lock bolt with an anti-excessive screwing function according to claim 13, wherein the lugs are provided on the glossy surface and evenly distributed in the circumferential direction; and
wherein, an end of each lug facing the threaded surface is an inclined surface, and an end of the lug far from the rod part is an arc surface.

15. A lock bolt with an anti-excessive screwing function, comprising a screw, one end of which is threaded with a nut, wherein
the nut comprises a sleeve body; two ends outside the sleeve body are respectively sleeved with a gasket and a connecting sleeve, the connecting sleeve is provided with a connecting rib attached to the sleeve body, and the connecting rib can be broken after being subjected to torsion overload;
wherein, a limit structure for limiting the movement of the gasket is provided between the gasket and the sleeve body.

16. The lock bolt with an anti-excessive screwing function according to claim 15, wherein the limit structure comprises a limit ring provided on an outer surface of the sleeve body, and the parts of the sleeve body on the two sides of the limit ring are respectively configured as a hexagonal prisms and a cylinder; and
wherein, the hexagonal prism is attached to the connecting rib, and the cylinder is inserted and fitted with the gasket.

17. The lock bolt with an anti-excessive screwing function according to claim 16, wherein the limit structure further comprises a limit protrusion provided on the edge of the cylinder and a clamping ring provided on the inner surface of the gasket.

18. The lock bolt with an anti-excessive screwing function according to claim 17, wherein when the cylinder is inserted into the gasket, the limit protrusion passes through the clamping ring and abuts against the end face of the clamping ring.

19. The lock bolt with an anti-excessive screwing function according to claim 15, wherein the screw comprises a head part and a rod part; one end of the rod part close to the head part is provided with a glossy surface, and the other end far from the head part is provided with a threaded surface.

20. The lock bolt with an anti-excessive screwing function according to claim 19, wherein lugs that fill a gap between screw holes are evenly provided on the glossy surface in a circumferential direction.
